(19) United States
(12) Patent Application Publication
(10) Pub. No.: US 2009/0316414 A1
(43) Pub. Date: Dec. 24, 2009

(54) LED LAMP

(75) Inventors: LIN YANG, Shenzhen City (CN); YE-FEI YU, Shenzhen City (CN); XIN-XIANG ZHA, Shenzhen City (CN); JER-HAUR KUO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: Fu Zhun Precision Industry (Shen Zhen) Co., Ltd., Shenzhen City (CN); Foxconn Technology Co., Ltd., Tu-Cheng (TW)

(21) Appl. No.: 12/202,397

(22) Filed: Sep. 1, 2008

(30) Foreign Application Priority Data
Jun. 18, 2008 (CN) 200810067912.5

(51) Int. Cl. F21V 7/00

(52) U.S. Cl. 362/296.01

(57) ABSTRACT

An LED lamp (100) includes a lamp enclosure (10), an LED module and a reflective plate (50). The lamp enclosure has a groove (15) and an opening (156). The opening is located above and communicates with the groove. The LED module and the reflective plate are received in the groove of the lamp enclosure. The LED module is oriented towards the opening. The reflective plate is located between the LED module and opening in such a manner that at least a portion of light (71) emitted by the LED module is firstly directed to the reflective plate, and then reflected from the reflective plate to an internal surface (115) of the lamp enclosure, and at last reflected from the internal surface to the opening.

### BACKGROUND

1. Field of the Invention

The present invention relates to a light emitting diode (LED) lamp, and more particularly to an LED lamp which can provide an even and soft light.

2. Description of Related Art

As an energy-efficient light, an LED lamp has a trend of substituting for the fluorescent lamp for a lighting purpose. In order to increase the overall lighting brightness, a plurality of LEDs are often incorporated into a lamp. It is well known that the LEDs are arranged in a form of point light sources in the lamp. Thus, discomfort glare is caused by the LED light sources. Even worse, the highly focused and intensive light sources of the LEDs may cause damages to an viewer's eyes when he (she) directly gazes at the LEDs.

What is needed, therefore, is an LED lamp which can overcome the above mentioned disadvantages.

### SUMMARY

An LED lamp includes a lamp enclosure, an LED module and a reflective plate. The lamp enclosure has a groove and an opening. The opening communicates with and is located above the groove. The LED module and the reflective plate are received in the groove of the lamp enclosure. The LED module is oriented towards the opening. The reflective plate is located between the LED module and the opening in such a manner that at least a portion of light emitted by the LED module is firstly directed to the reflective plate, from which the portion of light is reflected to an internal surface of the lamp enclosure, and from which the portion of light is finally reflected to an outside of the lamp via the opening.

Other advantages and novel features of the present invention will become more apparent from the following detailed description when taken in conjunction with the accompanying drawings.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of an LED lamp in accordance with a first embodiment of the present invention.

FIG. 2 is an exploded, isometric view of the LED lamp shown in FIG. 1, viewed from a different aspect.

FIG. 3 is a cross-sectional view of the LED lamp shown in FIG. 1, taken along a line III-III thereof.

FIG. 4 is a cross-sectional view of an LED lamp in accordance with a second embodiment of the present invention.

### DETAILED DESCRIPTION

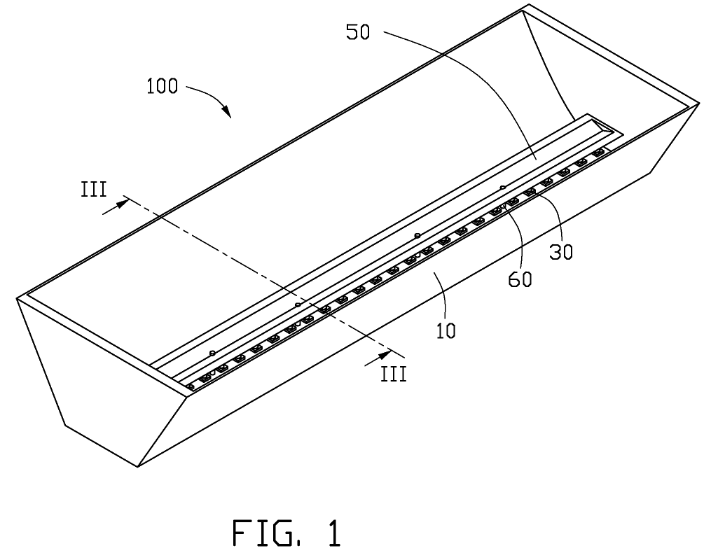

Referring to FIG. 1, an LED lamp 100 in accordance with a first embodiment of the present invention is shown. The LED lamp 100 comprises a lamp enclosure 10, an LED module 30 and a reflective plate 50. The lamp enclosure 10 has a concave configuration. The LED module 30 and the reflective plate 50 are received in the lamp enclosure 10. The LED module 30 is attached to a top face of a bottom plate 111 of the lamp enclosure 10. The reflective plate 50 is connected to the lamp enclosure 10 via four screws 60 and keeps a distance from the bottom plate 111 of the lamp enclosure 10.

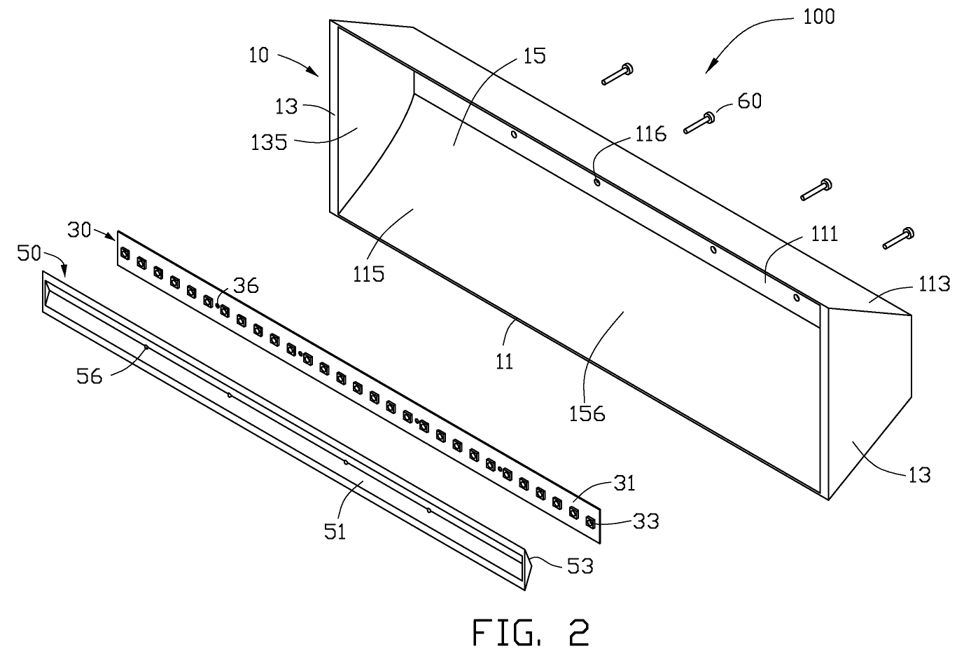

Referring to FIG. 2, the lamp enclosure 10 includes a concave cover 11 and two side walls 13 integrally formed at two longitudinal ends of the cover 11 respectively. The cover 11 and the side walls 13 cooperatively form a groove 15. The lamp enclosure 10 defines an opening 156 at a top side thereof. The opening 156 is located above and communicates with the groove 15. The cover 11 has an elongated configuration, which has an arched cross section. The cover 11 includes the bottom plate 111 and two lateral plates 113. The bottom plate 111 is an elongated, rectangular, flat plate and is configured to form a bottom side of the cover 11. The lateral plates 113 are elongated and extend integrally from two opposite sides of the bottom plate 111 respectively. The lateral plates 113 extend slantingly from the bottom plate 111 to the opening 156. The cover 11 has an arched, internal surface 115. The bottom plate 111 defines four holes 116 therein.

The side walls 13 are trapeziform, flat plates. The side walls 13 are integrally connected to longitudinal ends of the bottom plate 111 and the lateral plates 113. Either of the side walls 13 has an internal surface 135. The internal surfaces 135, 115 are located inside the lamp enclosure 10 and face the groove 15. The groove 15 becomes wider and wider from bottom to top of the lamp enclosure 10. A high reflective material, for example nickel or aluminum, is painted on the internal surfaces 115, 135.

The LED module 30 includes an elongated substrate 31 having a rectangular shape, and a plurality of LEDs 33 equidistantly mounted on the substrate 31. Preferably, the substrate 31 has a layer of a printed circuit on which the LEDs 33 are electrically mounted. The substrate 31 has an elongated configuration and extends along a parallel direction to the bottom plate 111. The substrate 31 defines a plurality of holes 36 corresponding to the holes 11 6 of the bottom plate 111.

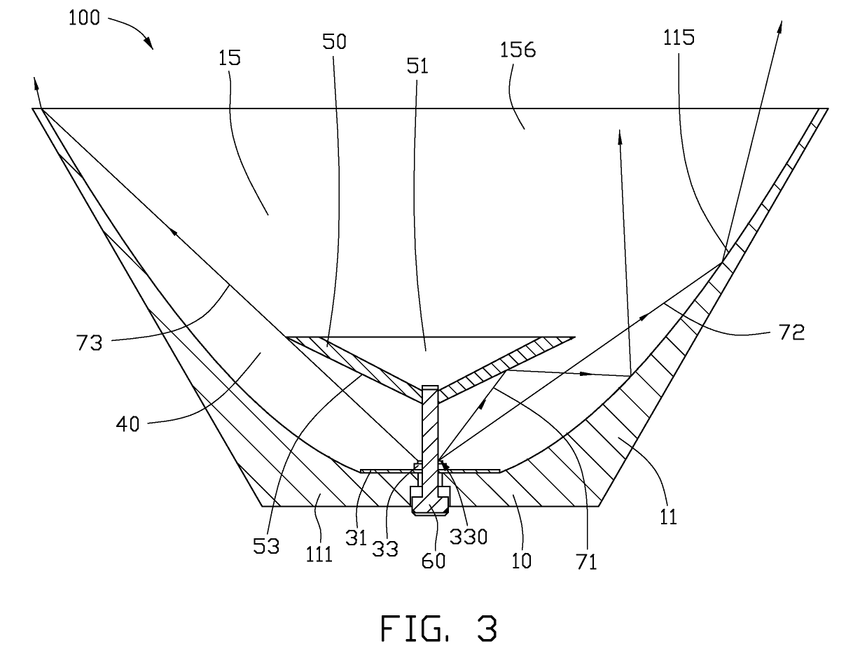

Also referring to FIG. 3, the reflective plate 50 is located over the LED module 30. The reflective plate 50 is smaller than the opening 156. A space 40 is defined between the internal surface 115 and the reflective plate 50. The reflective plate 50 has a V-shaped end cross section. The reflective plate 50 is elongated and extends parallel to the substrate 31. The reflective plate 50 defines a triangular groove 51 in a top side thereof. The reflective plate 50 has a reflective surface 53 in a bottom side thereof, which faces the LED module 30 and a lower portion of the internal surface 115 of the cover 11. The reflective surface 53 is formed by two slanting surfaces and is convex towards the LED module 30. A high reflective material, for example nickel or aluminum, is painted on the reflective surface 53. The reflective plate 50 defines a plurality of fixing holes 56. The fixing holes 56 correspond to the holes 36, 116. The screws 60 extend through the holes 36, 116 to engage in the fixing holes 56 so as to connect the reflective plate 50 to the lamp enclosure 10.

Each of the LED 33 has a light emitting surface 330. The light emitting surface 330 is oriented towards the reflective surface 53 and the opening 156. The reflective plate 50 is positioned relative to the lamp enclosure 10 in such a manner that light emitted by the LEDs 33 is directed towards the reflective surface 53 or the internal surfaces 115, 135 firstly. For example, a portion of light 71 is firstly directed to the reflective surface 53, and then reflected from the reflective surface 53 to the internal surface 115, and at last reflected from the internal surface 115 to an outside of the LED lamp 100 through the opening 156. Another portion of light 72 is firstly directed to the internal surface 115, and then reflected from the internal surface 115 to the outside of the LED lamp 100 through the opening 156. Finally, a portion of light 73 which is emitted from a periphery of the light emitting surface 330 moves along a direction tangent to a periphery of the reflective surface 53 and is reflected by a top edge of the internal surface 115 to reach the outside of the LED lamp 100. There is another portion of light (not shown) which is directed to the internal surface 135 and then reflected from the internal surface 135 to reach the outside of the lamp 100 through the opening 156.

In the present invention, the LED lamp 100 is constructed in such a manner that the LEDs 33 do not directly emit their light to the outside of the lamp through the opening 156. Thus, a user of the LED lamp 100 will not directly gaze at the LEDs 33 and discomfort glare and damages to the user's eyes is accordingly avoided. The LED lamp 100 can provide the user with a soft and even light source.

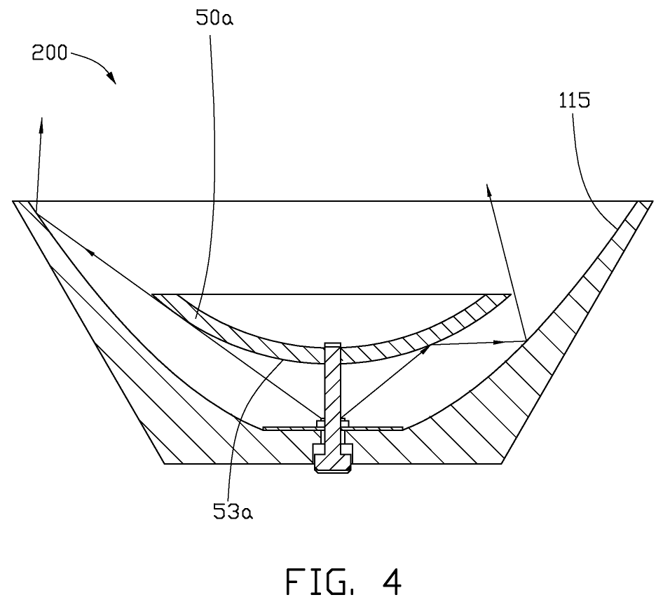

Referring to FIG. 4, an LED lamp 200 in accordance with a second embodiment of the present invention is shown. The LED lamp 200 has a similar configuration to the LED lamp 100. The LED lamp 200 differs from LED lamp 100 only in the structure of the reflective plate 50a. The reflective plate 50a has a curved, arched configuration. The reflective plate 50a has a reflective surface 53a, which has a similar contour to the internal surface 115.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp comprising:
a lamp enclosure;
an LED module; and
a reflective plate, wherein
the lamp enclosure comprises a groove and an opening, the opening communicates with the groove, the LED module and the reflective plate are received in the groove of the lamp enclosure, the LED module is oriented towards the opening, the reflective plate is located between the LED module and the opening in such a manner that at least a portion of light emitted by the LED module is firstly directed to the reflective plate, and then reflected from the reflective plate to an internal surface of the lamp enclosure, and at last reflected from the internal surface to an outside of the LED lamp through the opening.

2. The LED lamp as claimed in claim 1, wherein the LED module includes at least one LED, the at least one LED has a light emitting surface, the reflective plate has a reflective surface, the reflective surface is configured to face the light emitting surface.

3. The LED lamp as claimed in claim 2, wherein a portion of the light, which is emitted from a periphery of the light emitting surface moves along a direction tangent to a periphery of the reflective surface and reflected by an edge of the internal surface of the lamp enclosure to the outside of the LED lamp.

4. The LED lamp as claimed in claim 2, wherein the lamp enclosure includes a concave cover and two side walls connected to two longitudinal ends of the cover respectively, and the cover has an elongated configuration with an arched internal surface, and the cover and the side walls cooperate to form the groove, and the opening is defined in a top of the cover and located above the groove.

5. The LED lamp as claimed in claim 4, wherein the LED module includes an elongated substrate and a plurality of LEDs equidistantly mounted on the substrate, the substrate is elongated and attached to a bottom of the cover.

6. The LED lamp as claimed in claim 5, wherein the reflective plate is located over the LED module, and the reflective plate has an elongated configuration with a V-shaped end cross section.

7. The LED lamp as claimed in claim 6, wherein the reflective plate has a triangular groove in a top thereof.

8. The LED lamp as claimed in claim 7, wherein at least a screw is used to extend through the lamp enclosure and the LED module to connect with the reflective plate thereby fixing the reflective plate in the groove.

9. The LED lamp as claimed in claim 5, wherein the reflective surface has a curved contour.

10. The LED lamp as claimed in claim 4, wherein the cover includes a bottom plate and two lateral plates, and the bottom plate is an elongated, rectangular, flat plate, and the lateral plates are elongated and extend slantingly from two opposite sides of the bottom plate respectively.

11. The LED lamp as claimed in claim 10, wherein the bottom plate and the substrate defines a plurality of holes, and the reflective plate defines a plurality of fixing holes corresponding to the holes of the bottom plate and the substrates, screws extending through the holes to engage in the fixing holes thereby to connect the reflective plate to the lamp enclosure.

12. An LED lamp comprising:
a lamp enclosure;
an LED module; and
a reflective plate, wherein
the lamp enclosure comprises a groove and an opening, the opening is located above and communicates with the groove, the LED module and the reflective plate are received in the groove of the lamp enclosure, the LED module is oriented towards the opening, the reflective plate is located between the LED module and opening in such a manner that light emitted by the LED module is reflected by the lamp enclosure before the light leaves the LED lamp through the opening.

13. The LED lamp as claimed in claim 12, wherein the opening is defined in a top of the lamp enclosure, and the LED module is attached to a bottom of the lamp enclosure.

14. The LED lamp as claimed in claim 13, wherein the groove becomes wider and wider from the bottom to the top of the lamp enclosure.

15. The LED lamp as claimed in claim 14, wherein the reflective plate has a reflective surface facing the LED module, the reflective surface has a similar contour to an internal surface of the lamp enclosure.
